(19) United States
(12) Patent Application Publication
(10) Pub. No.: US 2015/0155891 A1
(43) Pub. Date: Jun. 4, 2015

(54) DUAL MODE WWAN AND WLAN TRANSCEIVER SYSTEMS AND METHODS

(71) Applicant: QUALCOMM Incorporated, San Diego, CA (US)

(72) Inventor: Samir Salib Soliman, Poway, CA (US)

(73) Assignee: QUALCOMM Incorporated, San Diego, CA (US)

(21) Appl. No.: 14/095,779

(22) Filed: Dec. 3, 2013

(51) Int. Cl. H04B 1/00

(52) U.S. Cl. CPC H04B 1/0067; H04W 88/06

(57) ABSTRACT

A method of wireless communication includes communicating by receiving by a first transceiver a first type of signal, receiving by a second transceiver a first type of signal, carrier aggregating the signals received by the first transceiver and the signal the second transceiver. The method includes detecting a second type of signal and switching the first transceiver to receive the second signal type while the second transceiver continues to receive the first type of signal.

### BACKGROUND

1. Field

The present disclosure relates generally to communication systems and processes, and more particularly, to communication systems and processes that employ transceivers that support carrier aggregation. Particular embodiments relate to systems and processes with transceivers that support Long Term Evolution (LTE) carrier aggregation and are adapted to support Wireless Local Area Networks.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). These better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements may be applicable to other multi-access technologies and the telecommunication standards that employ these technologies.

Advanced wireless devices can have multiple transceivers or radios (e.g., Wireless Wide Area Networks (WWAN) such as but not limited to 2G, 3G, 4G, wireless local area networks (WLAN) also known as Wi-Fi, wireless personal area networks (WPAN) such as Bluetooth and zigbee, RFID (Radio Frequency Identification), etc.) that receive and send different types of signals (e.g., signals at different frequencies and bandwidths). Various implementations incorporate dedicated hardware to support the plurality of standards. Even in cases where some integration can be performed, for example, with wireless LAN and PAN, these circuits include one RF front-end per communication standard. Multiple RF front ends per wireless device can make the implementations complex, bulky and costly.

### SUMMARY

A method of wireless communication includes, but is not limited to any one or combination of, receiving by a first transceiver a first type of signal, receiving by a second transceiver a first type of signal, carrier aggregating the signals received by the first transceiver and the second transceiver. The method includes detecting a second type of signal and switching the first transceiver to receive the second signal type while the second transceiver continues to receive the first type of signal. The first transceiver and the second transceiver are configured to receive a first type signal during carrier aggregation. The first transceiver and the second transceiver are configured to receive a second type of signal during MIMO (Multiple-Input Multiple-Output) operation. The method includes the first type of signal being a WWAN signal and the second type of signal is a WLAN signal. The method includes switching performed by a controller that is connected to the first transceiver. The controller may be configured to send control signals to the first transceiver to bypass at least one FDD duplexer. The method includes adjusting the characteristics of a filter within the first transceiver to allow the first transceiver to receive the second type of signal. The method may include adjusting, using a transceiver controller, that is configured to adjust a filter characteristics within the at least one of the transceivers to allow the at least one transceiver to receive the second signal type. The method includes the transceiver controller being configured to provide different control signals based on a signal that is being processed. The method includes changing a transceiver controller configured to change at least one control signal to create a signal path within the first transceiver to process a second type of signal.

A system of wireless communication that includes a mobile device for wireless communication that includes a carrier aggregation radio having two or more transceivers that are configured to aggregate two signals of a first signal type and at least one of the transceivers configured to receive a second signal type while the other transceivers continue to receive the first signal type. During MIMO (Multiple-Input Multiple-Output) operations, the system that includes the first transceiver and the second transceiver is configured to receive a second type of signal. The mobile device may include a transceiver controller that is configured to adjust a filter characteristics within the at least one of the transceivers to allow the transceiver to receive the second signal type. The mobile device also includes a baseband processor that is configured to detect the type of signal being received by the at least one transceiver and the baseband processor is configured to process the signal differently based on whether the transceiver is receiving the first signal type or the second signal type. The transceiver controller in the mobile device may send a message to the baseband processor regarding the change in the filter characteristics in the at least one of the transceivers so that the baseband processor may be configured to process a different type of signal.

The transceiver controller in the mobile device is configured to switch between filters in at least one of the transceivers. Switching between filters may allow the at least one of the transceivers to receive a second type of signal. The mobile device configured to receive the first signal type is a WWAN signal and where the second signal type is a WLAN signal. The mobile device including a controller configured to transmit control signals to a plurality of single pole double throw switches of the at least one transceiver to create a signal path that bypasses a FDD duplexer. The mobile device including at least one transceiver that includes a plurality of single pole double throw switches that when activated create a signal path to bypass a FDD duplexer within the transceiver.

An apparatus for wireless communication, the apparatus comprising a means for aggregating two signal of a first signal type received by a first transceiver and a second transceiver and a means for receiving, by at least one transceiver, a second signal type upon detecting a second signal type. The apparatus includes a means for changing the characteristics of a filter within a first transceiver based on the second signal type. The apparatus further includes a means for detecting the second signal type. The apparatus may include a mean for generating a first control signal to change the first transceiver to receive a second type of signal while the second transceiver continues to receive a first type of signal.

### BRIEF DESCRIPTION OF THE DRAWINGS

FIG. 1 is a diagram illustrating an example of a network for wireless communication.

FIG. 2A is a diagram illustrating an example of an RF Module in carrier aggregation mode.

FIG. 2B is a diagram illustrating an example of an RF Module that is configured to receive a first type of signal and a second type of signal.

FIG. 3 is a flow chart of a method of wireless communication that may be implemented by the system in FIGS. 1-2B.

FIG. 4 is a schematic diagram of a system for implementing wireless communication.

FIG. 5 is a flow chart of a method of wireless communication that may be implemented by the systems in FIGS. 1-2B and 4.

FIG. 6 is a schematic diagram of a system for implementing wireless communication.

FIG. 7 is a flow chart of a method of wireless communication that may be implemented on the system in FIG. 6.

### DETAILED DESCRIPTION

Embodiments of the present disclosure are directed to dual mode wireless WAN and wireless LAN transceiver systems. A plurality of transceivers may be configured to aggregate two or more signals of different frequencies in a mobile phone, smart phone, tablet, or other electronic mobile communication device, referred to herein as user's equipment (UE). Examples of UEs 102 include a cellular phone, a smart phone, a touch input tablet, a session initiation protocol (SIP) phone, a laptop, a personal digital assistant (PDA), a satellite radio, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, wireless device, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Carrier aggregation of two signals allows a set of transceivers to receive signals at different frequencies, to aggregate the signals such that the mobile device can receiver a wider bandwidth signal of the first type and deliver higher throughput. In various embodiments, a first type of signal is a WWAN signal and a second type of signal is a WLAN signal. In various embodiments, at least one of the transceivers may be configured to receive a second type of signal while the other transceiver continues to receive the first type of signal, without carrier aggregation.

In another embodiment, methods include re-configuring at least one transceiver, that is part of a set of transceivers that are configured to perform carrier aggregation for a first signal type, to send/receive a second signal type while the other transceivers continue to send/receive the first signal type.

Various combinations of transceiver may be used to perform carrier aggregation (e.g. two transceivers tuned to two different frequencies, each transceiver receiving a single 5 MHz signal such that the combined bandwidth of both transceivers is 10 MHz for a particular signal type). In some embodiments, the different frequencies may be separated from each other and spread across the frequency band. In some embodiments, the different frequencies may be adjacent to each other in the frequency band. Carrier aggregation is used in LTE and WCDMA in order to increase the bandwidth, and thereby increase the bitrates. Carrier aggregation can be used for both FDD (Frequency Division Duplex) and TDD (Time Division Duplex). Each aggregated carrier is referred to as a component carrier, CC. For example, if a component carrier can have a bandwidth of 1.4, 3, 5, 10, 15 or 20 MHz and various component carriers can be aggregated to achieve a bandwidth of up 100 MHz or more. In FDD the number of aggregated carriers can be different in DL as compared to UL. However, the number of UL component carriers is equal to or lower than the number of DL component carriers. The individual component carriers can also be of different bandwidths. When TDD is used the number of CCs and the bandwidth of each CC is the same for DL and UL.

In particular, when two transceivers are used for carrier aggregation (e.g. LTE) and the UE detects that another signal (e.g. WIFI) is available, a signal is sent to a controller in the UE to configure one of the transceivers in the UE to process the wireless WAN signal, while the other transceiver remains in LTE mode. Configuring a transceiver in the UE may include changing the frequency (tuning to WLAN band(s)) and adjusting filter characteristics (center frequency, bandwidth, amplitude and phase responses, etc.) or switching filters to accept signals that have a center frequency and bandwidth of the second signal type.

As part of, or in addition to adjusting the filter characteristics or switching filters, the baseband processor may be reconfigured or programmed to receive signals of the second signal type (e.g. WLAN or WIFI) from a first transceiver while the baseband processor continues to receive and process the signals of a first signal type (e.g. CDMA, 3G, HSPA, HSPA+, LTE, LTE advanced) from the second or other transceivers.

In some embodiments, detection software on the UE may detect the signals that are accessible on the UE or can be received by the UE. The searching and detection process is controlled by the serving Evolved Node B (eNB) and can be done periodically based on a predetermined schedule. Upon detecting a second signal (a signal of a second type) that can be received, detection software in the UE may cause a signal to be sent to the controller in the UE, to cause the UE to change one transceiver to stop receiving the first signal that was being received and switch the transceivers to receive a second signal. The other transceivers may continue to receive a first type of signal.

The first signal type may be an LTE signal, where two transceivers in the UE are configured to aggregate signals at different center frequencies. Upon the UE detecting a WLAN signal and communicating the event to EPC, one of the transceivers may stop receiving the LTE signal and be re-configured to receive the WLAN signal while the other transceiver continues to receive the LTE signal. In other embodiments, the first signal may be a WCDMA signal and the second signal may be a WLAN signal. In other embodiments, the first signal may be a LTE signal and the second signal may be a HSPA+ signal. In other embodiments, the first signal may be a WLAN signal and the second signal may be a WWAN signal. Other embodiments may employ any other combination of two different signals for the first and second signal.

The detailed description set forth below in connection with the appended drawings relates to various example configurations and is not intended to represent the only configurations in which the concepts described herein may be practiced.

Several aspects of telecommunication systems will now be presented with reference to various example apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executable, threads of execution, procedures, functions, etc., whether referred to as software, firmware, middleware, microcode, hardware description language, or otherwise.

The modulation and multiple access scheme employed by the access networks may vary depending on the particular telecommunications standard being deployed. In LTE, OFDM is used on the down link (DL) and SC-FDMA is used on the up link (UL) to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the cdma2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

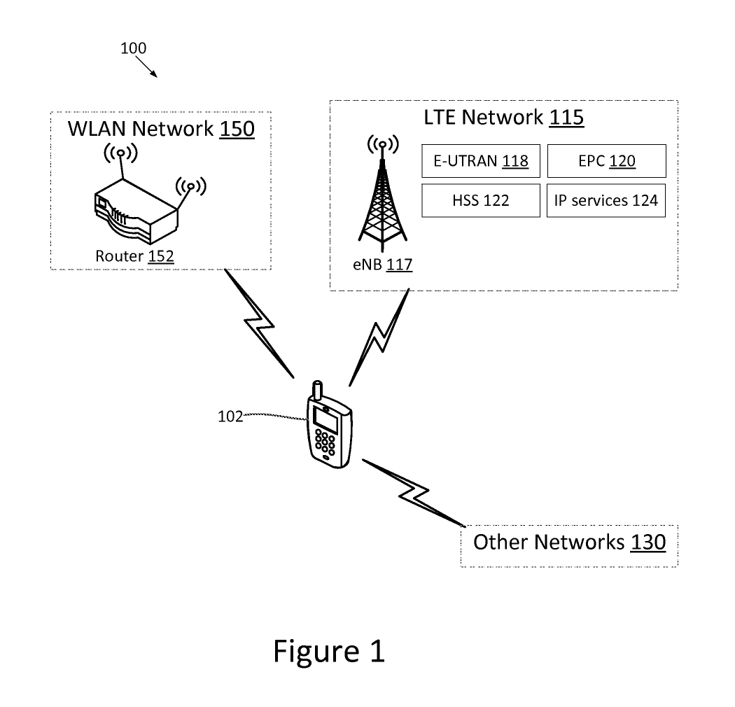

FIG. 1 is a diagram that illustrates a network 100. The network 100 includes an LTE network 115, a WLAN network 150 and other networks 130. Other networks 130, may include, but are not limited to, one or more cdma2000, WCDMA and HSPA networks. The UE 102 may be configured to connect to each of the networks 115, 130, and 150. The LTE network 115 may be referred to as an Evolved Packet System (EPS). The LTE Network 115 may include one or more user equipment (UE) 102, an Evolved Universal Terrestrial Radio Access Network (E-UTRAN) 118, an Evolved Packet Core (EPC) 120, a Home Subscriber Server (HSS) 122, and an Operator's IP Services 124. The LTE Network 115 can interconnect with other access networks, but for simplicity, those entities/interfaces are not shown. As shown, the LTE Network 115 provides packet-switched services. However, the various concepts presented throughout this disclosure may be extended to networks providing circuit-switched services.

The E-UTRAN 118 includes or operates with an evolved Node B (eNB) 117 and other eNBs (not shown). The eNB 117 may be connected to the other eNBs via a backhaul (e.g., an X2 interface). The eNB 117 may also be referred to as a base station, a base transceiver station, a radio base station, a radio transceiver, a transceiver function, a basic service set (BSS), an extended service set (ESS), or some other suitable terminology. The eNB 117 provides an access point to the EPC 120 for a UE 102.

The eNB 117 is connected by an S1 interface to the EPC 120. The EPC 120 includes a Mobility Management Entity (MME), other MMEs, a Serving Gateway, and a Packet Data Network (PDN) Gateway. The MME is the control node that processes the signaling between the UE 102 and the EPC 120. Generally, the MME provides bearer and connection management. All user IP packets are transferred through the Serving Gateway, which itself is connected to the PDN Gateway. The PDN Gateway provides UE IP address allocation as well as other functions. The PDN Gateway is connected to the Operator's IP Services 124.

With reference again to FIG. 1, carrier aggregation is a technique that can be used by the UE 102 and eNodeB 117. The base station 117 and the UE 102 communicate with each other using component carriers (CCs) that may have, for example, up to a 20 MHz bandwidth. In order to support data rates of 1 Gbps, a transmission bandwidth of up to 100 MHz may be required. Carrier aggregation is a technique that allows for aggregating CCs for transmission. For example, five CCs of 20 MHz bandwidth each can be aggregated to achieve a high bandwidth transmission of 100 MHz. The CCs that are aggregated may have the same or different bandwidths, may be adjacent or non-adjacent CCs in a same frequency band, or may be CCs in different frequency bands. Thus, in addition to achieving high bandwidth, another motivation for carrier aggregation is to allow for the use of a fragmented spectrum.

FIG. 1 also includes a WLAN network 150. A UE 102 may access the WLAN network 150 by connecting with a router 152. A UE 102 may connect over the router 152 that provides a Wi-Fi signal to allow the UE 102 to communicate with, for example, a wide area network such as the Internet and other resources. In some embodiments, the UE 102 may not include a dedicated antenna that is configured to send and receive only Wi-Fi signals. A dedicated WLAN antenna may include a plurality of components, such as but not limited to, a RF ASIC, RF front-end ASIC, WLAN antennas and WLAN baseband processor. In the embodiments discussed in FIGS. 1-7, the UE 102 may not have a dedicated WLAN antenna and transceiver. Nonetheless, the UE 102 may communicate with the WLAN network 150 by using one or more of the WWAN transceivers to communicate with the WLAN network 150. In these embodiments, the UE 102 may re-configure one of transceivers that are configured to send/receive WWAN signals to establish a connection with the WLAN network 150 while the other transceivers continue to and/receive WWAN signals.

Various advantages may be realized by using the above configuration. The UE 102 does not need a dedicated WLAN antenna and transceiver that occupy volume within the UE 102. A lack of a dedicated WLAN antenna and transceiver also reduces the number of components within the UE 102. Moreover, the dedicated WLAN antenna and transceiver can be extraneous when WLAN network 150 is inaccessible, and removing extraneous components in a UE 102 can help reduce cost.

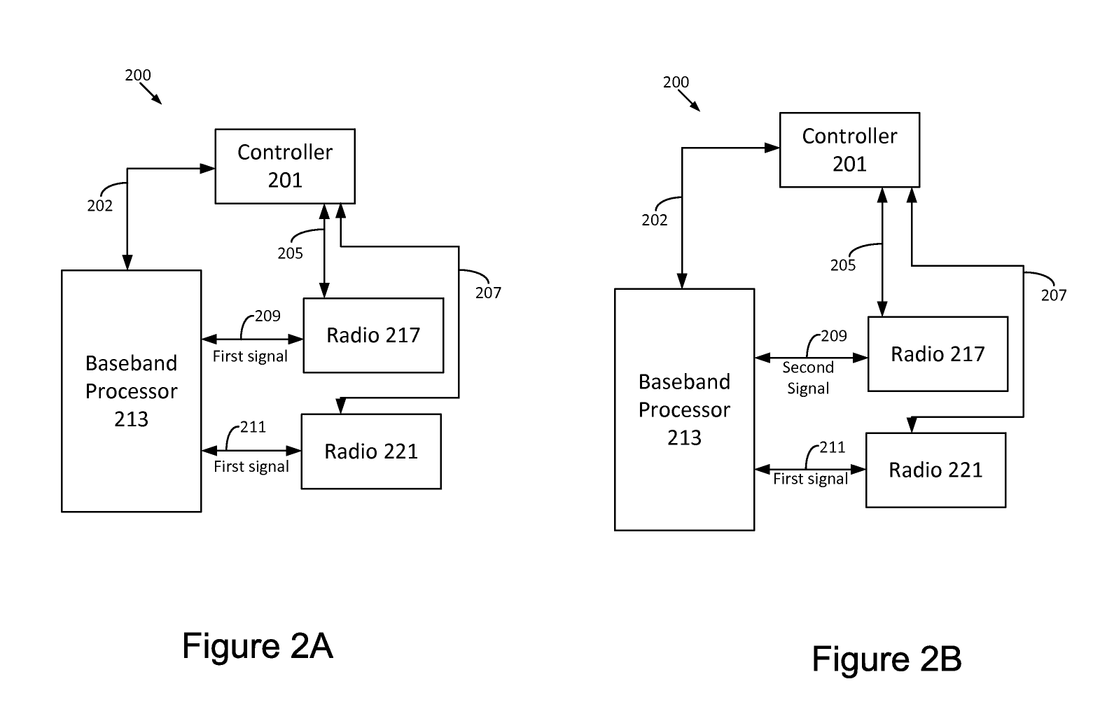

FIGS. 2A and 2B illustrate a carrier aggregation operation RF module 200 that may be part of a UE 102. FIG. 2A shows RF module 200 in a carrier aggregation mode, while FIG. 2B shows the RF module 200 in a mode for receiving two different signal types, without aggregating those signals. The RF module 200 may include, among other components, a controller 201, a baseband processor 213, a radio 217 and a radio 221. The controller 201 may have at least three control signal paths, such as but not limited to, control signal path 202, control signal path 205, and control signal path 207.

In the carrier aggregation mode shown in FIG. 2A, controller 201 may send control signals on (control signal path 205 and control signal path 207) to control the radio 217 and the radio 221 to receive a first type of signal. In other embodiments, the radios 217 and 221 may be controlled by another component in the UE 102, such as but not limited to, software on the UE 102 that is running the baseband processor 213, or another processor on the UE 102. In various embodiments, the control signal on control signal path 205 and control signal on the control signal path 207 sets the filters within the radios 217 and 221 to receive a first type of signal.

The baseband processor 213 may inform the controller 201 that it is receiving a first type of signal, and the controller 201 may inform the baseband processor 213 that the filters are set to receive a first type of signal, via control signal path 202. In FIG. 2A the baseband processor 213 may be configured to receive two signals, one on signal path 209 and the other on signal path 211, from radio 217 and radio 221, respectively. Both signals paths 209 and 211 in FIG. 2A carry a first type of signal (e.g. WWAN signals). After receiving the two signals from signal paths 209 and 211, the baseband processor 213 may perform carrier aggregation. For example, the signal on signal path 209 may be 5 MHz wide and the signal on signal path 211 may be 5 MHz wide. In the above example, the baseband processor 213 may aggregate the two signals on signal paths 209 and 211 to allow the UE 102 to receive a 10 MHz signal.

In some embodiments, radios 217 and 221 may be tuned to two different bands because a carrier may not be able to get a contiguous 10 MHz band. For example, LTE signals may be at a plurality of different bands, including, but not limited to the following bands: 700 MHz, 800 MHz, 1900 MHz, 2.3 GHz, and 2.6 GHz. Accordingly, in that example embodiment, radio 217 may be receive an LTE signal at, for example, 700 MHz and the signal may be 5 MHz wide, while radio 221 receives another LTE signal at 1900 MHz and that is also 5 MHz wide. Carrier aggregation performed by the baseband processor 213 allows a carrier to provide a 10 MHz signal to a UE 102. Although, an LTE signal is discussed above, other signal types (e.g., but not limited to, WWAN, WCDMA) may be aggregated by the baseband processor 213 in a similar manner.

While operating in carrier aggregation mode, UE 102 may determine that a WLAN signal is available and the UE 102 may prefer to connect to a WLAN signal. Generally, WLAN signals under certain circumstances can provide a faster data transfer rate, faster throughput, and are less costly for the user of the UE 102. However, as discussed above the UE 102 need not include a WLAN antenna and transceiver assembly.

FIG. 2B illustrates the RF module 200 in a mode for receiving two different types of signals. The module 200 in FIG. 2B may be configured to receive a second signal type (e.g. but not limited to WLAN) while the RF module 200 continues to also receive a first signal type (e.g. but not limited to WWAN). After routinely scanning for a WLAN signal, the UE 102 may detect a WLAN signal that is accessible to the UE 102. In response, the UE 102, after negotiating with the EPC, may send a signal to the controller 201 to switch to WLAN receiving mode. Upon receiving the WLAN signal, the controller 201 determines that at least one of the radios 217 or 221 may be switched to receive a WLAN signal instead of a WWAN signal that the radios 217 and 221 had been receiving in FIG. 2A. Accordingly, in this example embodiment, the controller 201 may determine that radio 217 will begin receiving the WLAN signal.

In the mode of FIG. 2B, the controller 201 is configured to send a signal on signal path 205 to change the characteristics of the filters in radio 217, or the controller 201 may choose a different filter in the radio 217 such that the radio 217 will filter out frequencies other than WLAN frequencies. The controller 201 may also send a signal to the baseband processor 213 on signal path 202 such that the baseband processor 213 will process a WLAN signal. Accordingly, the baseband processor 213 is configured to process both WWAN and WLAN signals, based on the control signal received from the controller 201. Although radio 217 is switched to receive WLAN signals, radio 221 may continue to receive WWAN signals in FIG. 2B. Moreover, because radio 217 and radio 221 are receiving different types of signals (e.g. one WWAN signal and one WLAN signal), the baseband process is not performing carrier aggregation on those signals. Instead, UE 102 is able to receive a WLAN signal by using one of the radios 217 and 221, each of which is configurable to receive WWAN and/or WLAN signals, simultaneously.

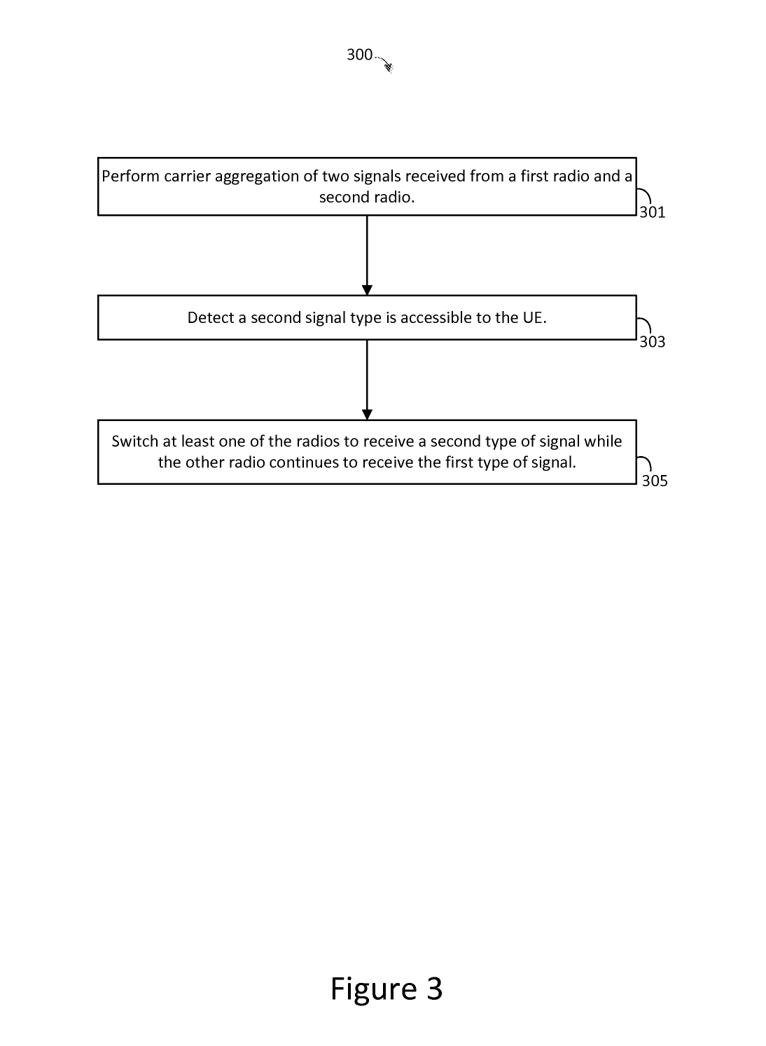

FIG. 3 is a flow chart of a method 300 of wireless communication that may be performed by the systems disclosed in FIGS. 1-2B. Method 300 is directed to a UE 102 that is initially operating in a carrier aggregation made (e.g. as in FIG. 2A), where two or more transceivers or radios are tuned to two different frequencies of the same signal type. The two or more signals that are received by the two or more transceivers are aggregated to allow the UE 102 to realize a high data transfer rate as described above with respect to FIG. 2A. At step 301, the UE 102 may perform carrier aggregation of two signals (of the same signal type) that are received from a first radio and a second radio.

At step 303, the UE 102 detects that a second type of signal is accessible to the UE 102. For example, the UE 102 may be configured to periodically scan appropriate frequencies for a WLAN signal and, upon detecting a WLAN signal, the UE 102 may also determine that the UE 102 is capable of authenticating to the WLAN signal and receive the WLAN signal. The UE informs the EPC that a WLAN signal has been detected and the UE desires to connect to the WLAN network 150. In other embodiments, the UE 102 may receive input from a user to detect a WLAN signal and begin the authentication process for a WLAN signal.

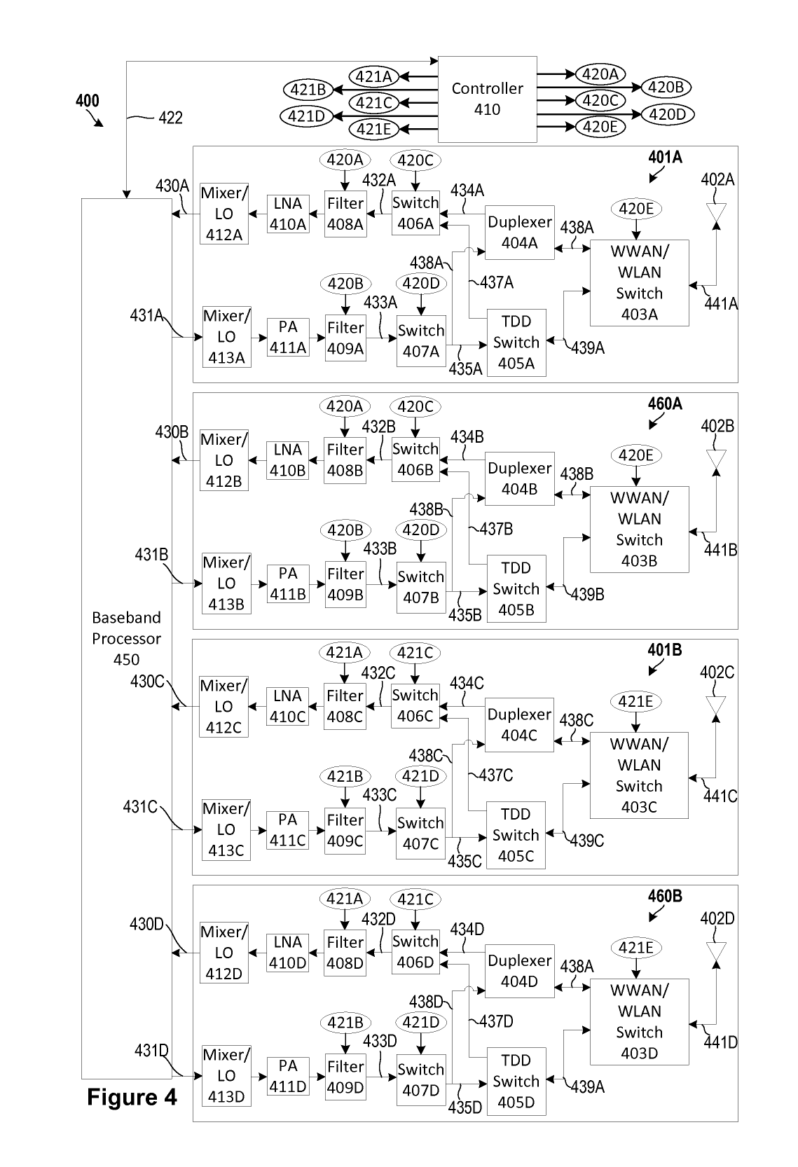

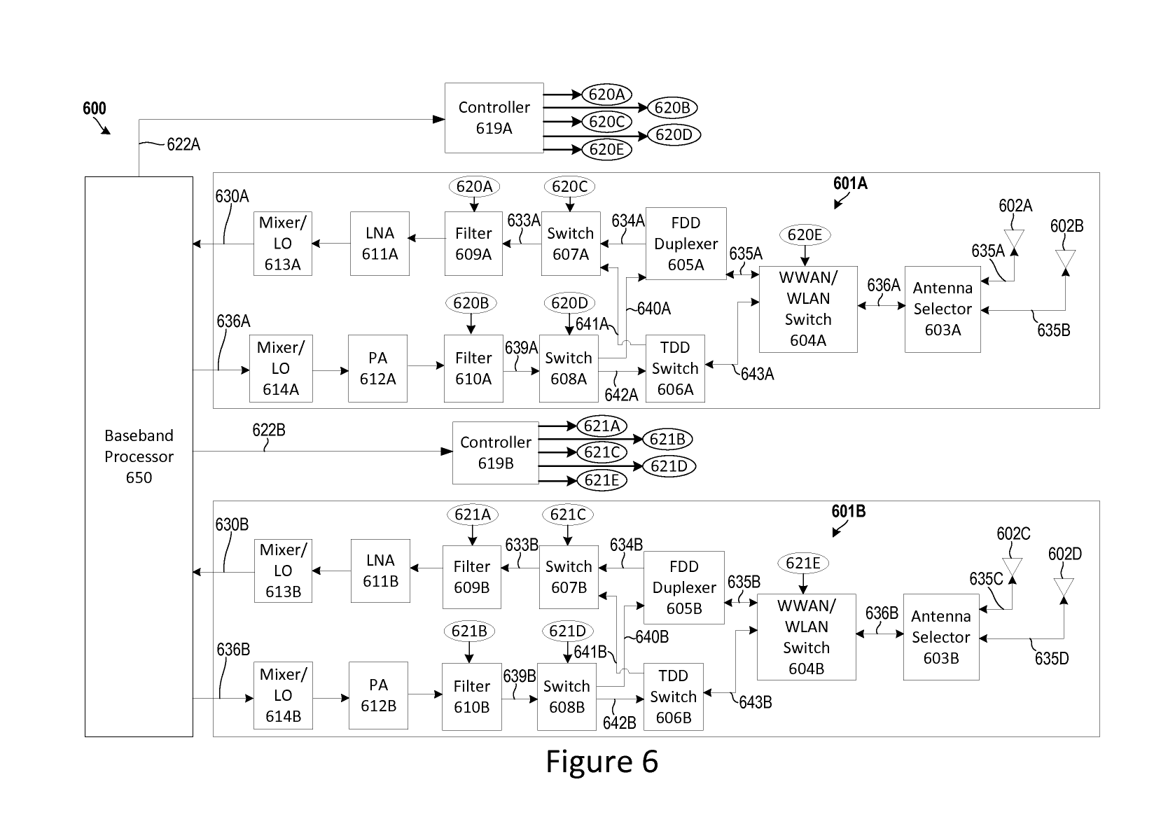

Next at step 305, the controller 201 switches at least one of the radios in the UE 102 to receive a second type of signal while the other radio continues to receive the first type of signal. As discussed above with respect to FIG. 2B, switching the at least one radio includes changing the characteristics of the filters within the radio (e.g. changing frequency in one embodiment). Alternatively, or in addition, as discussed in greater detail below in FIGS. 4 and 6, switching the at least one radio may include activating one or more switches to create a signal path that allows the WLAN signal to bypass some of the WWAN components.

FIG. 4 is a schematic diagram of an example of a transceiver assembly 400 that may be used in UE 102. FIG. 4 is an implementation of FDD (Frequency Division Duplexing) carrier aggregation transceiver with diversity combining. In other embodiments, a TDD carrier aggregation transceiver with diversity combining may be modified to send/receive a second signal. One of the filters in the TDD carrier aggregation transceiver may be controlled to receive a frequency associated with the second type of signal and other components within the transceiver may be configured to process either the first type of signal or the second type of signal. FIG. 4 illustrates a combined WWAN and WLAN transceiver assembly 400 operating with diversity combining Transceiver assembly 400 has two radios such as the radios shown in FIGS. 2A and 2B. A first radio in the transceiver assembly 400 is a combination of transceivers 401A and 460A. A second radio in the transceiver assembly 400 is a combination of transceivers 401B and 460B. As shown in FIG. 4, transceiver 460A and transceiver 460B are used as diversity transceivers. For example, transceiver 401A may be a primary transceiver and transceiver 460A may be a diversity transceiver and both transceivers 401A and 460A form one radio. Similarly, transceiver 401B may be a primary transceiver and transceiver 460B may be a diversity transceiver and both transceivers 401B and 460B form one radio. The antennas or radios used to provide a diversity arrangement can be in the same physical housing and/or include two separate but equal antennas in the same location. Diversity antennas can be physically separated from the radios and each other, so that one encounters less multipath propagation effects than the other.

In FIG. 4, other components, such as but not limited to, AGC (Automatic gain control), A/D (Analog to Digital Converter), D/A (Digital to Analog Converter), digital filters, and various other components are not shown to simplify the drawing. The above mentioned components and various other components may be part of the transceiver assembly. For example, in the receiving portion of a transceiver, a filter may be connected to output a signal to a low noise amplifier that is connected to output a signal to a mixer/local oscillator. The mixer/local oscillator may down convert the signal and is connected to output the signal to a baseband processor. Similarly, in a transmitting portion of a transceiver, the baseband processor may be connected to output a signal to a mixer/local oscillator that up converts the signal. The mixer/local oscillator is connected to output a signal to a power amplifier that is connected to output a signal to a filter. In some embodiments, front end components that are capable of processing both WWAN and WLAN signals would be part of the transceiver assemblies discussed herein in FIGS. 2A, 2B, 4, 6, 8 and 10.

Referring again to FIG. 4, the transceiver assembly 400 includes, among other electric components, a transceiver 401A, a transceiver 401B, a baseband processor 450, a transceiver 460A, a transceiver 460B, and a controller 410. The transceiver assembly 400 may include a plurality of other electrical components that are not shown. As discussed above, transceivers 401A and 460A comprise a first radio, while transceivers 401B and 460B comprise a second radio. In some embodiments, the circuitry within each transceiver is identical. However, in other embodiments, transceivers 401A and 460B may be configured to receive a different set of control signals from the controller 410 compared to the set of control signals received by transceivers 401B and 460 B.

Each of the transceivers 401A, and 401B comprise a plurality of components, such as but not limited to, antennas 402A and 402C, WWAN/WLAN switch 403A and 403C, duplexer 404A and 404C, TDD switches 405A and 405C, switches 406A and 406C, switches 407A and 407C, filters 408A and 408C, filters 409A and 409C, LNA (low noise amplifier) 410A, LNA 410C, PA (power amplifier) 411A, PA 411C, mixer/LO 412A, mixer/LO 412C, mixer/LO 413A and mixer/LO 413C. As discussed in greater detail above, the transceivers 401A and 401B may also include other components that are configured to handle two different types of signals.

The antennas 402A, 402B, 402C, and 402D are configured to send or receive various types of wireless signals. Antennas 402A, 402B, 402C, and 402D may send or receive signals to/from signal paths 441A, 441B, 441C, and 441D, respectively. In some embodiments, the antennas 402A, 402B, 402C, and 402D may be configured to send/receive WWAN and WLAN signals. In some embodiments, diversity antenna 402B may be located a suitable distance or separated away from antenna 402A within UE 102. Similarly, in some embodiments, diversity antenna 402D may be located away from antenna 402C within UE 102.

In some embodiments, the WWAN/WLAN switches 403A, 403B, 403C, and 403D may be single pole double throw switches. In other embodiments, the WWAN/WLAN switches 403A, 403B, 403C, and 403D may be a different type of switch or switching mechanism. The WWAN/WLAN switches 403A, 403B, 403C, and 403D may be implemented by any type of switching circuit that connects one pole to either one of the two throws. The single pole for each switch may be connected to its respective antennas, as show in FIG. 4. The first throw of each switch may be connected to duplexers 404A, 404B, 404C and 404D for WWAN signals. The second throw of each switch may be connected to the TDD switches 405A, 405B, 405C, and 405D for WLAN signals. Each of the WWAN/WLAN switches 403A, 403B, 403C, and 403D may be controlled by one of the respective control signals 420E or 421E. When controller 410 sends a control signal 420E to WWAN/WLAN switches 403A and 403B, the WWAN/WLAN switches 403A and 403B switch from the first throw (e.g. Duplexer 404A) to the second throw (e.g. TDD switch 405A). The controller 410 may send a signal to the WWAN/WLAN switches 403A and 403B or to WWAN/WLAN switches 403C, and 403D in order to use one of the associated radios to send/receive either a WWAN or WLAN signal.

WWAN/WLAN switch 403A may transmit or receive a signal from antenna 402A via signal path 441A. In some embodiments, depending on control signal 420E, the WWAN/WLAN switch 403A may transmit or receive either a WWAN signal or a WLAN signal. When WWAN/WLAN switch 403A receives a WWAN signal, the signal is transmitted to duplexer 404A via signal path 438A. In other embodiments, a WWAN signal may be transmitted from duplexer 404A through signal path 438A to WWAN/WLAN switch 403A and from WWAN/WLAN switch 403A to antenna 402A.

In some embodiments, control signal 420E switches the WWAN/WLAN switch 403A to receive or transmit a WLAN signal. The WLAN signal may be sent or received from antenna 402A via signal path 441A. After receiving the WLAN signal, the switch WWAN/WLAN 403A sends the WLAN signal to a TDD switch 405A. The WLAN signal may be transmitted by WWAN/WLAN switch 403A after the WLAN signal is received from TDD switch 405. Moreover, after receiving the WLAN signal for transmission, the WWAN/WLAN switch 403A provides the signal to the antenna 402A via signal path 441A.

The duplexer 404A is connected to switch 406A for receiving a WWAN signal, and the duplexer 404A is connected to switch 407A for transmitting a WWAN signal. Duplexer 404A may receive signals from switch 407A through signal path 437A, and duplexer 404A may send signals to switch 406A though signal path 434A. Like duplexer 404A, duplexers 404B, 404C, and 404D are connected to switches 406B, 406C, and 406D, respectively and the duplexers 404B, 404C, and 404D are connected to switches 407B, 407C, and 407D, respectively. Duplexers 404B, 404C, and 404D may send signals to switches 406B, 406C, and 406D through signals paths 434B, 434C, and 434D, respectively. In various embodiments, one or more duplexers 404A, 404B, 404C and 404D are used to send or receive signals when one or more transceivers 401A, 401B, 460A, and 460B are sending or receiving WWAN signals. In other embodiments, the one or more TDD switches 405A, 405B, 405C, and 405D are used to send or receive signals when one or more transceivers 401A, 401B, 460A and 460B are sending or receiving WLAN signals.

The TDD switches 405A, 405B, 405C, and 405D operate in time division duplexing such that the uplink is separated from downlink by the allocation of different time slots in the same frequency band. In some embodiments, the TDD switches 405A, 405B, 405C, and 405D are used to process WLAN signals, when the transceivers 401A, 401B, 460A, and 460B are configured to send or receive a WLAN signal. In various embodiments, the TDD switches 405A, 405B, 405C, and 405D are single pole double throw switches.

In various embodiments, switch 406A may be a single pole double throw switch. The pole of switch 406A is connected to a filter 408A that is connected to the switch 406A via signal path 432A. The first throw of switch 406A is connected from the duplexer 404A via signal path 434A. The second throw of the switch 406A is connected from the TDD switch 405A via signal path 438A. Switch 406A may receive control signal 420C from the controller 410. Switch 406B may be connected in a similar manner as switch 406A, to similar components in the transceiver 460A. For example, switch 406B may receive signals on signal paths 434B and 438B, control signal path 420C and send signals out on signal paths 432B.

Switch 406C of transceiver 401B may send one or more signals to the filter 408C via signal path 432C, and receive control signal 421C from the controller 410. The control signal 421C determines which throw the switch 406C connects to the pole. Switch 406C may receive signals on signal path 438C and signal path 434C. Similarly, switch 406D receives signal 434D and control signal 421C. Switch 406D sends signals to the filter 408D via signal path 432D. Switch 406D also reviewing signals from TDD switch 405D via signal path 438D. Control signals 421A, 421B, 421C, and 421D determine the throw that is connected to the pole by switches 406A, 406B, 406B, and 406D.

In various embodiments, switch 407A may be a single pole double throw switch. The pole of switch 407A is connected to a filter 409A that is connected to the switch 407A via signal path 433A. The first throw of switch 407A is connected to the duplexer 404A via signal path 437A. The second throw of the switch 407A is connected to the TDD switch 405A via signal path 435A. Switch 407A may also receive control signal 420D from the controller 410. Switch 407B may be connected in a similar manner as switch 407A, to similar components in the transceiver 460A. For example, switch 407B may receive signals on signal path 433A, control signal path 420D, and send signals out on signal paths 435B and 437B.

Switch 407C of transceiver 401B may receive signals from the filter 409C via signal path 433C, and receive control signal 421D from the controller 410. Switch 407C may send signals on signal path 437C and signal path 435C. Similarly, switch 407D receives signal 433D and control signal 421D. Switch 407D may send signal to the duplexer 404D via signal path 437D and to TDD switch 405D via signal path 435D.

Filter 408A may comprise one or more filters (e.g. a bank of a plurality of filters) configured to allow signals that are at various center frequencies and with a certain bandwidth to be processed. In various embodiments, the filter 408A may reject other signals (e g jamming or interfering signals). Filter 408A may receive signals from the switch 406A via signal path 432A, and control signals 420A. The filter 408A may process the received signal and send a signal via signal path 430A for the baseband processor 450. As mentioned above, there may be other electrical components between the filter 408A and the baseband processor 450. The electrical components may include a mixer/LO 412A, LNA 410A, a down-converter, and the like. The filter 408A may receive a control signal 420A from the controller 410. The control signal 420A may select a filter within the bank of filters in filter 408A, to switch the transceiver 401A from receiving a first type of signal to receiving a second type of signal. The control signal 420A may also control the filter 408A to switch back to receiving and processing a first type of signal when a second type of signal is unavailable or undetected. In other embodiment, the control signal 420A may change a characteristic (center frequency, bandwidth, amplitude and phase responses, etc.) of the filter 408A.

Filter 409A may receive signals from the baseband processer 450 via signal path 431A, mixer/LO 413A and PA 411A. Filter 409A may receive control signal 420B from the controller 410. The control signal 420B may configure the filter 409A to send a filtered signal to switch 407A. The filter 409A may comprise a bank of a plurality of filters, and the control signal may select one of the filters within filter 409A. Filter 409B may receive a signal 431B and control signal 420B. Filter 409B may provide a signal to be transmitted via signal path 433B to switch 407B. Filter 409C may receive a signal 431C and control signal 421B and, in response, may provide a signal to be transmitted via signal path 433C to switch 407C. Filter 409C may receive a signal 431D and control signal 421B. Filter 409D may provide a signal to be transmitted via signal path 433D to switch 407D. In other embodiment, the control signal 420B may change a characteristic (center frequency, bandwidth, amplitude and phase responses, etc.) of the filter 409A.

LNA 410A receives signals from filter 408A. LNA 410A is a low-noise amplifier that amplifies the received signals. In some embodiments, LNA 410A compensates for the effects of noise that may have been injected into the signal from the other components in the transceiver 401A. In various embodiments, LNA 410A may be configured to receive and amplify different types of signals. For example, LNA 410A may receive a first type of signal (e.g. WWAN) or a second type of signal (e.g. WLAN) based on the type of signal that is filtered by the filter 408A. In some embodiments, the signal from filter 408A may inform the LNA 410A which type of signal is being processed and the LNA 410A may adjust its amplifying characteristics to amplify the type of signal that is being received. In various embodiments, LNA 410A may receive a control signal from the controller 410 that informs the LNA 410A regarding the type of signal that is being processed. LNA 410B, LNA 410C, and LNA 410D each receive signals from filters 408B, 408C, and 408D, respectively. LNA 410B, LNA 410C and LNA 410D each perform similar functions as LNA 410A. In various embodiments, LNA 410B receives signals from filter 408B and sends signals to the mixer/LO 412B. LNA 410C receives signals from filter 408C and sends signals to the mixer/LO 412C. LNA 410D receives signals from filter 408D and sends signals to the mixer/LO 412D.

PA 411A may receive signals from mixer/LO 413A. The PA 411A may be a low-noise amplifier that is used to amplify signals that are received from the mixer/LO 413A. The PA 411A transmits the amplified signals to filter 409A. In various embodiments, PA 411A may be configured to receive and amplify different types of signals. For example, PA 411A may receive a first type of signal (e.g. WWAN) or a second type of signal (e.g. WLAN) based on the type of signal that is sent by the mixer/LO 413A. In some embodiments, the signal from the mixer/LO 413A may inform the PA 411A which type of signal is being processed and the LNA 411A may adjust its amplifying characteristics to amplify the type of signal that was received. In various embodiments, PA 411A may receive a control signal from the controller 410 that informs the PA 411A regarding the type of signal that is being processed. PA 411B, PA 411C, and PA 411D each receive signals from mixer/LO 413B, 413C, and 413D, respectively. PA 411B, PA 411C and PA 411D each perform similar functions as PA 411A. In various embodiments, PA 411B receives signals from mixer/LO 413B and sends signals to the filter 409B. In various embodiments, LNA 411C receives signals from mixer/LO 413C and sends signals to the filter 409C. In various embodiments, LNA 411D receives signals from mixer/LO 413D and sends signals to the filter 409D.

Mixer/LO 412A down converts the RF signal from LNA 410A and sends the RF signal to the baseband processor 450. Mixer/LO 412A may be configured for multi-mode operation (such as, but not limited to dual mode operation) are described in detail below. A mixer device can selectively adapt (by changing a mode of operation) to accommodate different communication standards and protocols. The mixer/LO 412A mixes and down converts the output from the LNA 410A with the output from a local oscillator (LO). In various embodiments, control signal 420A may be provided to the mixer/LO 412A. The control signal from the controller 410 may choose the appropriate local oscillation frequency or mixer characteristics within the mixer/LO 412A. The mixer/LO 412A may be configured to mix a plurality of different types of signals and down convert the plurality of different types of signals. For example, the mixer/LO 412A may process WWAN signals within a particular time period. During another time period, the mixer/LO 412A may process WLAN signals. The determination regarding the type of signal that is being processed may depend on the operational mode of the transceiver 401A. Mixer/LO 412B, mixer/LO 412C, and mixer/LO 412D may operate in a similar manner as mixer/LO 412A (i.e., mixing and down converting the received signals). In some embodiments, the mixer/LO 412C and mixer/LO 412D may receive a different type of signal than mixer/LO 412A and mixer/LO 412B. Mixer/LO 412B may down convert signals from LNA 410B and send signals to the baseband processor 450. Mixer/LO 412C may down convert signals from LNA 410C and send signals to the baseband processor 450. Mixer/LO 412D may down convert signals from LNA 410D and send signals to the baseband processor 450.

Mixer/LO 413A up converts signals from baseband processor 450 and sends the up-converted signals to PA 411A. Mixer/LO 413A may be configured for multi-mode operation (such as, but not limited to dual mode operation) that is described in detail below. A mixer/LO 413A can selectively adapt (by changing a mode of operation) to accommodate different communication standards and protocols (e.g. WWAN or WLAN). The mixer/LO 413A mixes and up converts the output from the baseband processor 450 with the output from a local oscillator (LO). In various embodiments, control signal 420B may be provided to the mixer/LO 413A. The control signal from the controller 410 may choose the appropriate local oscillation frequency or mixer characteristics within the mixer/LO 413A to process the received signal. The mixer/LO 413A may be configured to mix and up convert a plurality of different types of signals. For example, the mixer/LO 413A may process WWAN signals within a time period. In another time period, the mixer/LO 413A may process WLAN signals. The determination of the type of signal that is processed may depend on the operational mode of the transceiver 401A. Mixer/LO 413B, mixer/LO 413C, and mixer/LO 413D may operate in a similar manner as mixer/LO 412A. Mixer/LO 413B may up convert signal from the baseband processor 450 and send signals to the PA 411B. Mixer/LO 413C may up convert signals from the baseband processor 450 and send signals to the PA 411C. Mixer/LO 413D may up convert signals from the baseband processor 450 and send signals to the PA 411D.

The controller 410 may send and receive signals to/from the baseband processor 450 via signal path 422. The controller 410 provides control signals 420A, 420B, 420C, 420D, 420E, 421A, 421B, 421C, 421D, and 421E that control the various components of transceivers 401A, 401B, 460A, and 460B. The control signals from the controller 410 controls the transceiver to create at least one signal path for receiving a second type of that is different than a first type of signal that the transceiver was previously receiving.

The baseband processor 450 may convert analog signals to digital signals and digital signals to analog signals. The baseband processor 450 is configured to perform signal processing and may manage radio control function such as signal generation, modulation, encoding, frequency shifting, digital filtering, and signal transmission. In various embodiments, the baseband processor 450 may include an IFFT (inverse fast Fourier transform), a D/A (digital to analog converter) and an A/D (analog to digital converter) not shown here for simplifying the drawings. The baseband processor 450 as shown in FIG. 4, is configured to receive signals from the controller 410 on signal path 422, and from the filters 408A, 408B, 408C, and 408D via signal paths 430A, 430B, 430C, and 430D, respectively. The baseband processor 450 is configured to send signals to filters 409A, 409B, 409C, and 409D using signal paths 431A, 431B, 431C, and 431D. In some embodiments, the baseband processor 450 is configured to receive and process both WWAN signals and/or WLAN signals. In other embodiments, the baseband processor 450 may send/receive a WWAN signal from each transceiver 401A, 401B, 460A, and 460B. In other embodiments, the baseband processor 450 may send/receive a first type of signal from transceivers 401A and 460A while transceivers 401B and 460B send/receive a second or different type of signal. In an example embodiment, the first type of signal is a WWAN signal, and a second type of signal is a WLAN signal. The baseband processor 450 may be configured to process both types of signals simultaneously. In other embodiments, the baseband processor 450 may send/receive a WWAN signal to/from transceivers 401A and 460A, while transceivers 401B and 460B may send/receive a WLAN signal. In various embodiments, the baseband processor 450 may determine which signal type to process based on inputs received from the controller 410. In other embodiments, the baseband processor 450 may receive a signal from UE 102 that the baseband processor 450 should receive and process a WLAN signal because the UE 102 has detected an accessible WLAN signal. The baseband processor 450 may send a signal on signal path 422 to inform the controller 410 to send control signals to at least one of the transceivers to control the transceiver(s) to send/receive the WLAN signal to send to/from the baseband processor 450.

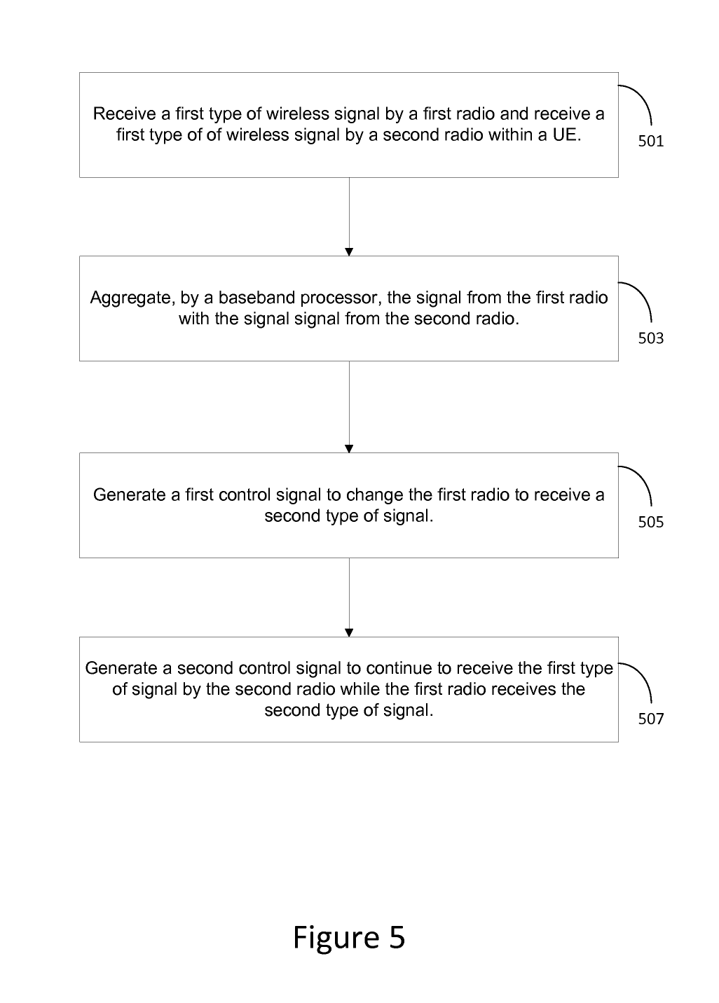

FIG. 5 is a flow chart of a method of wireless communication that may be implemented by the system in FIG. 4. In other embodiments, the flow chart of the method in FIG. 5 of may be implemented by the systems in FIGS. 1-2B. In some embodiments, a radio may comprise of at least two antenna transceivers, i.e. transceivers 401A and 460A from a first radio, while transceivers 401B and 460B make a second radio. A radio with two transceivers may use one transceiver (i.e. 401A or 401B) as a primary transceiver and the other transceiver (i.e. 460A or 460B) as a diversity transceiver. At step 501, the transceivers 401A and 460A (first radio) receives a first type of wireless signal and transceivers 401B and 460B (second radio) also receives the first type of wireless signal. The baseband processor 450 aggregates the signal, from the first radio with the signal from the second radio, at step 503. For example, the radios and the baseband processor 450 may be configured to perform carrier aggregation such that the UE 102 receives a bandwidth that is larger than the bandwidths received by either the first radio or the second radio.

In particular, when the UE 102 is in carrier aggregation mode, the signals from transceivers 401A, 401B, 460A, and 460B are aggregated by the baseband processor 450. Moreover, control signals 420A, 420B, 421A, and 421B allow the controller 410 to select appropriate filters within the bank of filters in filters 408A-408D, and 409A-409D. In various embodiments, the center frequencies of filters 408A, 408B, 409A and 409B may be equal to each other. In various embodiments, the center frequencies of filters 408C, 408D, 409C, and 409D may be equal to each other. The In various embodiments, the bandwidths of each filters 408A-408D and 409A-409D may also be equal to each other.

In carrier aggregation mode the control signals from the controller allow the transceivers to use the duplexers 404A-404D. Control signal 420C may be configured to allow the switch 406A to receive signals from duplexer 404A. Control signal 420D may be configured to allow the switch 407A to send signals to duplexer 404A. Control signal 420C may be configured to allow the switch 406B to receive signals from duplexer 404B. Control signal 420D may be configured to allow the switch 407B to send signals to duplexer 404B. Control signal 421C may be configured to allow the switch 406C to receive signals from duplexer 404C. Control signal 421D may be configured to allow the switch 407C to send signals to duplexer 404C. Control signal 421D may be configured to allow the switch 407D to send signals to duplexer 404D. The control signals 420E and 421E are set to allow WWAN/WLAN switches 403A-403D to send and receive WWAN signals.

Next, the UE 102 may detect a second type of signal that is accessible to the UE 102. Upon detecting the second type of signal, at step 505, the controller 410 may generates a first control signal to configure the first radio (i.e. transceiver 401A and 460A) to receive a second type of signal (i.e. WLAN TDD). The controller 410 may create a signal path that bypasses the duplexers 404A-404D. In particular, the control signals 420A and 420B may select a filter from the filters 408A, 408B, 409A, 409B that process the second type of signal. The control signals 420C and 420D configure the switches 406A, 406B, 407A and 408B to send and receive signal to/from TDD switch 405A. The control signal 420E configures the WWAN/WLAN switches 403A-403B to send and receive WLAN signals.

Next at step 507, the controller 410 generates a second control signal such that the second radio continues to receive the first type of signal while the first radio receives the second type of signal. The control signals at step 507 may be similar to the control signals from step 503 for the second radio.

FIG. 6 illustrates a schematic diagram of a transceiver assembly 600 that uses diversity selection. The transceiver assembly 600 includes a transceiver 601A, transceiver 601B, controller 619A, controller 619B, and baseband processor 650. Unlike the transceiver assembly 400 in FIG. 4, the transceiver assembly 600 may perform diversity selection. In particular, each transceiver 601A and 601B has two antennas, and the transceiver may determine which antenna to use based on the signal quality that is received from each antenna. FIG. 6 is an implementation of FDD (Frequency Division Duplexing) carrier aggregation transceiver with diversity combining. In other embodiments, a TDD carrier aggregation transceiver with diversity combining may be modified to accept a second signal. One of the filters in the TDD carrier aggregation transceiver may be controlled to receive a frequency of the second type of signal.

Transceivers 601A and 601B each has similar components connected in a similar manner. For example, transceiver 601A includes two antennas 602A and 602B that are each connected to an antenna selector 603A by signal paths 635A and 635B, respectively. In various embodiments, the antenna selectors 603A may be a single pole double throw switch. The antenna selector 603A may be designed to select one of the antennas 602A or 602B to receive or send a signal based on the signal quality received from the antennas. Similarly, transceiver 601B includes two antennas 602C and 602D, each connected to an antenna selector 603B by signal paths 635C and 635D. The antenna selector 603B may be designed to select one of the antennas 602C and 602D to receive or send a signal based on the signal quality received from the antennas. In various embodiments, the antenna selectors 603A or 603B may send or receive a signal to/from WWAN/WLAN switches 604A or 604B via signal paths 636A or 636B.

In various embodiments, WWAN/WLAN switch 604A may receive a control signal 620E from the controller 619A. Similarly, WWAN/WLAN switch 604B may receive a control signal 621E from the controller 619A. Both WWAN/WLAN switches 604A and 604B may send or receive signals to/from the FDD duplexers 605A and 605B, respectively. The FDD duplexer 605A and 605B may operate in frequency division duplex mode for WWAN signals. WWAN/WLAN switches 604A and 604B may send or receive signals to/from the TDD switch 606A or TDD switch 606B. The time division duplex switches 606A and 606B may send or receive WLAN signals. Control signals 620E and 621E choose the type of signal that is received by the WWAN/WLAN switches 604A and 604B.

The FDD duplexer 605A sends and receives sends signals to/from the WWAN/WLAN switch 604A. The FDD duplexer 605B sends and receives signals to/from the WWAN/WLAN switch 604B. The FDD duplexer 605A sends a signal to switch 607A, and the FDD duplexer 605A receives a signal from switch 608A. The FDD duplexer 605B sends a signal to switch 607B, and the FDD duplexer 605B receives a signal from switch 608B.

The TDD switch 606A sends or receives signals to/from the WWAN/WLAN switch 604A. The TDD switch 606A receives signals from the switch 608A via signal path 642A. The TDD switch 606A sends signals to the switch 607A via signal path 641A. The TDD switch 606B sends or receives signals to/from the WWAN/WLAN switch 604B. The TDD switch 606B receives signals from the switch 608B via signal path 642B. The TDD switch 606A sends signals to the switch 607B via signal path 641B.

In various embodiments, switch 607A may be a single pole double throw switch. The switch 607A receives a control signal 620C from the controller 619A. The switch 607A receives a signal from FDD duplexer 605A via signal path 634A and from TDD switch 606A via signal path 641A. The switch 607A sends a signal to a filter 609A. Switch 607A is configured to send the signal from the FDD duplexer 605A when the transceiver is operating to receive a FDD signal, such as but not limited to, WWAN signal. Switch 607A is configured to send the signal from the TDD switch 606A when the transceiver 601A is configured to receive a TDD signal, such as but not limited to a WLAN signal.

In various embodiments, switch 607B may be a single pole double throw switch. The switch 607B receives a control signal 621C from the controller 619B. The switch 607B receives a signal from FDD duplexer 605B via signal path 634B and from TDD switch 606B via signal path 641B. The switch 607B sends a signal to a filter 609B. Switch 607B is configured to send the signal from the FDD duplexer 605B when the transceiver is operating to receive a FDD signal, such as but not limited to, a WWAN signal. Switch 607B is configured to receive the signal from the TDD switch 606B when the transceiver 601B is configured to receive a TDD signal, such as but not limited to a WLAN signal.

In various embodiments, switch 608A may be a single pole double throw switch. The switch 608A receives a control signal 620D from the controller 619A. The switch 607A receives a signal to a filter 610A via signal path 639A. The switch 608A sends a signal to FDD duplexer 605A via signal path 640A and to TDD switch 606A via signal path 642A. Switch 608A is configured to send the signal to the FDD duplexer 605A when the transceiver is operating to send a FDD signal, such as but not limited to, a WWAN signal. Switch 608A is configured to send the signal to the TDD switch 606A when the transceiver 601A is configured to send a TDD signal, such as but not limited to a WLAN signal.

Filter 609A may comprise one or more filters (e.g. a bank of a plurality of filters) configured to allow signals that are at various center frequencies and with a certain bandwidth to be processed. In various embodiments, the filter 609A may reject other signals (e g jamming signals). Filter 609A may receive signals from the switch 607A via signal path 633A, and may receive control signals 620A. The filter 609A may process the received signal and send a signal for the baseband processor 650. As mentioned above, there may be other electrical components between the filter 609A and the baseband processor 650. The electrical components may include a mixer, a local oscillator, a down-converter, and the like. The filter 609A may receive control signals 620A from the controller 619A. The control signals 620A may select a filter within a bank of filters located in the filter 609A to switch the transceiver 601A from receiving a first type of signal to receiving a second type of signal. The control signal 620A may also control the filter 609A to switch back to receiving and processing a first type of signal when a second type of signal is unavailable. In various embodiments, the first type of signal may be a WWAN signal, and the second type of signal may be a WLAN signal.

Filter 610A may comprise one or more filters (e.g. a bank of a plurality of filters) configured to allow signals that are at various center frequencies and with a certain bandwidth to be processed. In various embodiments, the filter 610A may reject other signals (e g jamming signals). Filter 610A may receive signals from the baseband processor 650 via signal path 636A. Filter 610A may also receive control signal 620B from the controller 619A. Filter 610A may send signals to switch 608A via signal path 639A. As mentioned above, there may be other electrical components between the filter 610A and the baseband processor 650. The electrical components may include a mixer, a local oscillator, a down-converter, and the like. The filter 610A may receive control signals 620B from the controller 619A. The control signals 620B may select a filter within a bank of filters located in the filter 610A to switch the transceiver 601A from sending a first type of signal to sending a second type of signal. The control signals 620B may also control the filter 610A to receive and process a first type of signal when a second type of signal is unavailable. In various embodiments, the first type of signal may be a WWAN signal, and the second type of signal may be a WLAN signal.

Filter 609B may comprise one or more filters (e.g. a bank of a plurality of filters) configured to allow signals that are at various center frequencies and with a certain bandwidth to be processed. In various embodiments, the filter 609B may reject other signals (e g jamming signals). Filter 609B may receive signals from the switch 607B via signal path 633B and filter 609B may receive control signals 621A. The filter 609B may process the received signal and send a signal on signal path 630B to the baseband processor 650. As mentioned above, there may be other electrical components between the filter 609B and the baseband processor 650. The electrical components may include a mixer, a local oscillator, a down-converter, and the like. The filter 609B may receive control signals 621A from the controller 619B. The control signals 621A may select a filter within a bank of a plurality of filters located in the filter 609B to switch the transceiver 601B from receiving a first type of signal to receiving a second type of signal. The control signals 621A may also control the filter 609B to receive and process a first type of signal when a second type of signal is unavailable. In various embodiments, the first type of signal may be a WWAN signal, and the second type of signal may be a WLAN signal.

Filter 610B may comprise one or more filters (e.g. a bank of a plurality of filters) configured to allow signals that are at various center frequencies and with a certain bandwidth to be processed. In various embodiments, the filter 610B may reject other signals (e g jamming signals). Filter 610B may receive signals from the baseband processor 650 via signal path 636B. Filter 610B may also receive control signals 621B from the controller 619B. Filter 610B may send signals to switch 608B via signal path 639B. As mentioned above, there may be other electrical components between the filter 610B and the baseband processor 650. The electrical components may include a mixer, a local oscillator, a down-converter, and the like. The filter 610B may receive control signals 621B from controller 619B. The control signals 621B may select a filter within a bank of a plurality of filters located in the filter 611A to switch the transceiver 601B from sending a first type of signal to sending a second type of signal. The control signals 621B may also control the filter 610B to receive and process a first type of signal when a second type of signal is unavailable. In various embodiments, the first type of signal may be a WWAN signal and the second type of signal may be a WLAN signal.

The baseband processor 650 may convert analog signals to digital signals and digital signals to analog signals. The baseband processor 650 is configured to perform signal processing and may manage radio control function such as signal generation, modulation, encoding, as well as frequency shifting and signal transmission. In various embodiments, the baseband processor 650 may include an IFFT (inverse fast Fourier transform), a D/A (digital to analog converter) and an A/D (analog to digital converter) not shown here for simplifying the drawings. The baseband processor 650 as shown in FIG. 6 is configured to receive signals from the controllers 619A and 619B on signal paths 622A and 622B, respectively. The baseband processor 650 may also receive signals from the mixer/LO 613A and mixer/LO 613B. The baseband processor 650 is configured to send signals to mixer/LO 614A and mixer/LO 614B by using signal paths 636A and 636B, respectively. In some embodiments, the baseband processor 650 is configured to receive and process both WWAN signals and WLAN signals. In other embodiments, the baseband processor 650 may send/receive a WWAN signal from the each transceiver 601A and 601B. In other embodiments, the baseband processor 650 may send/receive a first type of signal from transceivers 601A, while transceivers 601B send/receive a second type of signal. In an example embodiment, the first type of signal is a WWAN signal, and a second type of signal is a WLAN signal. The baseband processor 650 may be configured to process both types of signals, simultaneously. In other embodiments, the baseband processor 650 may send/receive a WWAN signal to/from transceiver 601A while transceiver 601B may send/receive a WLAN signal. In various embodiments, the baseband processor 650 may determine which signal type to process based on inputs received from the controller 619A or 619B. In other embodiments, the baseband processor 650 may receive a signal from the UE 102 or the controllers 619A and 619B that the baseband processor 650 should receive a second type of signal because the UE 102 has detected an accessible WLAN signal. The baseband processor 650 may send a signal on signal path 622A or 622B to inform the controller 619A or 619B to send control signals 620A-620E or 621A-619E to at least one of the transceivers 601A or 601B to control the transceiver(s) to send/receive the WLAN signal.

The controller 619A may send and receive signals to/from the baseband processor 650 via signal path 622A. The controller 619A provides control signals 620A, 620B, 620C, 620D, and 620E that control the various components of transceivers 601A. The control signals from the controller 619A control the transceiver to create at least one signal path for receiving a second type of signal that is different than a first type of signal that the transceiver 601A was previously receiving. In particular, the control signals 620A allow the controller to adjust the filter 609A. The control signals 620B allow the controller to adjust the filter 610A. The control signals 620C may change the switch 607A. For example, the control signals 620C may change the switch 607A to receive signals from the FDD duplexer 605A. Alternatively, the control signals 620C may change the switch 607A to receive and transmit the signals from the TDD switch 606A. The control signals 620D may change the switch 608A to send the signal to the FDD Duplexer 605A or to TDD switch 606A. The control signals 620E may change the WWAN/WLAN switch 604A to send or receive signals to/from the FDD duplexer 605A or send or receive signals to/from the TDD switch 606A.

The controller 619B may send and receive signals to/from the baseband processor 650 via signal path 622B. The controller 619B provides control signals 621A, 621B, 621C, 621D, and 621E that control the various components of transceivers 601B. The control signals from the controller 619B control the transceiver designed to create at least one signal path for receiving a second type of signal that is different than a first type of signal that the transceiver 601B was previously receiving. In particular, the control signal 621A allows the controller to adjust the filter 609B. The control signal 621B allows the controller to adjust the filter 610B. The control signals 610C may change the switch 607B to receive a signal from either the FDD duplexer 605B or from the TDD switch 606B. For example, the control signal 621C may change the switch 607B to receive signals from the FDD duplexer 605B. Alternatively, the control signal 620C may change the switch 607B to receive and transmit the signals from the TDD switch 606B. The control signals 620D may change the switch 608B to send the signal to the FDD Duplexer 605B or to TDD switch 606B. The control signal 620E may change the WWAN/WLAN switch 604B to send or receive signals to/from the FDD duplexer 605A or send/receive signals to/from the TDD switch 606B.

LNA 611A receives signals from filter 609A. LNA 611A is a low-noise amplifier that amplifies the received signals. In some embodiments, LNA 611A compensates for the effects of noise that may have been injected into the signal from other components in the transceiver 601A. In various embodiments, LNA 611A may be configured to receive different types of signals and amplify different types of signals. For example, LNA 611A may receive a first type of signal (e.g. WWAN) or a second type of signal (e.g. WLAN) based on the type of signal that is filtered by the filter 609A. In some embodiments, the signal from filter 609A may inform the LNA 611A which type of signal is being processed and the LNA 611A may adjust its amplifying characteristics to amplify the type of signal that is being received. In various embodiments, LNA 611A may receive a control signal from the controller 619A that informs the LNA 611A regarding the type of signal that is being processed. LNA 611B receives signals from filters 609B. LNA 611B performs similar functions as LNA 611A. In various embodiments, LNA 611B receives signals from filter 609B and sends signals to the mixer/LO 613B.

PA 612A receives signals from filter mixer/LO 614A and send signals to filter 610A. PA 612A is a power amplifier that amplifies the received signals. In some embodiments, PA 612A compensates for the effects of noise that may have been injected into the signal from other components in the transceiver 601A. In various embodiments, PA 612A may be configured to receive different types of signals and amplify different types of signals. For example, PA 612A may receive a first type of signal (e.g. WWAN) or a second type of signal (e.g. WLAN) based on the type of signal that is filtered by the filter 610A. In some embodiments, the signal from mixer/LO 614A may inform the PA 612A which type of signal is being processed and the PA 612A may adjust its amplifying characteristics to amplify the type of signal that is being received. In various embodiments, PA 612A may receive a control signal from the controller 619A that informs the PA 612A regarding the type of signal that is being processed. PA 612B receives signals from filters 610B. PA 612B performs similar functions as PA 612A. In various embodiments, PA 612B receives signals from mixer/LO 614B and sends signals to the filter 610B.

Mixer/LO 613A is configured to down convert output signals from LNA 611A and send signals to the baseband processor 650. Mixer/LO 613A may be configured for multi-mode operation (such as, but not limited to dual mode operation) that is described in detail below. A mixer/LO 613A can selectively adapt (by changing a mode of operation) to accommodate different communication standards and protocols. The mixer/LO 613A mixes and down converts the output signal from the LNA 611A with the output signal from a local oscillator (LO). In various embodiments, control signal 620A may be provided to the mixer/LO 613A. The control signal from the controller 619A may choose the appropriate local oscillation frequency or mixer characteristics within the mixer/LO 613A. The mixer/LO 613A may be configured to mix and down convert a plurality of different types of signals. For example, the mixer/LO 613A may process WWAN signals at a particular time period. In another time period, the mixer/LO 613A may process WLAN signals. The determination of the type of signal that is to be processed may depend on the operational mode of the transceiver. Mixer/LO 613B may operate in a similar manner as mixer/LO 613A. Mixer/LO 613B may down convert signals from LNA 611B and send signals to the baseband processor 650.

Mixer/LO 614A up converts signals received from baseband processor 650. Mixer/LO 614A sends the up-converted signals to PA 612A. Mixer/LO 614A may be configured for multi-mode operation (such as, but not limited to dual mode operation) are described in detail below. A mixer device can selectively adapt (by changing a mode of operation) to accommodate different communication standards and protocols (e.g. WWAN or WLAN). The mixer/LO 614A mixes and up converts the output from the baseband processor 650 with the output from a local oscillator (LO). In various embodiments, control signal 620B may be provided to the mixer/LO 614A. The control signal from the controller 619A may choose the appropriate local oscillation frequency or mixer characteristics within the mixer/LO 614A. The mixer/LO 614A may be configured to mix a plurality of different types of signals. For example, the mixer/LO 614A may process WWAN signals at a time period. In another time period, the mixer/LO 614A may process WLAN signals. The determination regarding the type of signal that is processed may depend on the operational mode of the transceiver. Mixer/LO 614B may operate in a similar manner as mixer/LO 614A. Mixer/LO 614B may up convert signals from the baseband processor 650 and send the signals to the PA 612B.

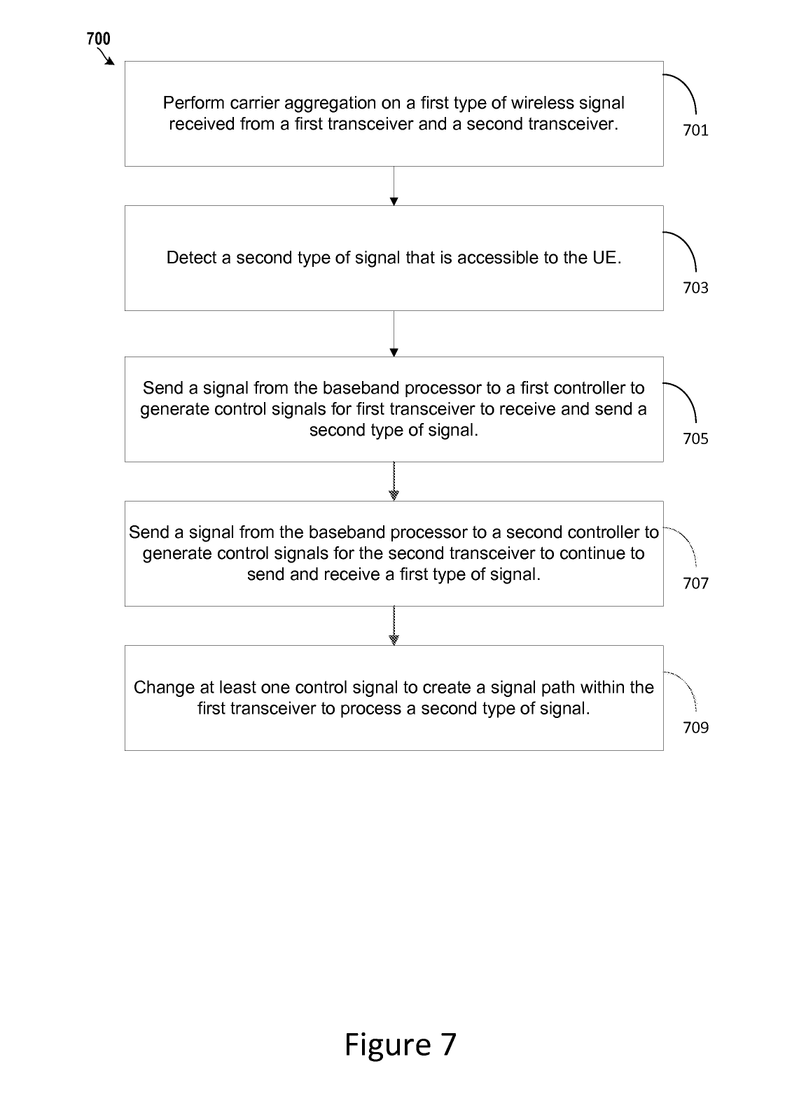

FIG. 7 is a flow chart of a method 700 of wireless communication that may be implemented by the system in FIG. 6. In other embodiments, the flow chart of the method 700 may be implemented by the systems in FIGS. 1-2B and 4. At step 701, the transceivers 601A and 601B may perform carrier aggregation on a first type of wireless signals that are received from a first transceiver 601A and a second transceiver 601B. Next at step 703, the UE 102 may detect a second type of signal that is accessible to the UE 102.

Next at step 705, the baseband processor 650 may send a signal to a first controller 619A to generate control signals (i.e. 620A, 620B, 620C, 620D, and 620E) for the first transceiver 601A to receive and send a second type of signal. Control signal 620A may change filter 609A to select a filter in the bank of filters having a center frequency and bandwidth (e.g. 2.4 GHz or 5 GHz) that conforms to the requirements of the second type of signal (e.g. WLAN). Control signal 620B may also select a similarly appropriate filter from the bank of filters that are within filter 610A. Control signal 620C may change the switch 607A to receive signals from the TDD switch 606A. Control signal 620D may change the switch 608A to send signals to the TDD switch 606A. Control signal 620E may switch the WWAN/WLAN switch 604A to send and receive signals to/from a TDD switch 606A.

At step 707, the baseband processor 650 sends a signal to a second controller 619B to generate control signals (e.g. 621A, 621B, 621C, 621D, and 621E) for the second transceiver 601B to continue to send and receive a first type of signal. Control signal 621A may allow filter 609B to select a filter in the bank of filters having a center frequency and bandwidth that conforms to the requirements of the first type of signal (e.g. WWAN). Control signal 621B may also select an appropriate filter from the bank of filters that are within filter 610B. Control signal 621C may configure the switch 607B to receive signals from the FDD duplexer 605B. Control signal 621D may configure the switch 608B to send signals to the FDD duplexer 605B. Control signal 620E may configure the WWAN/WLAN switch 604B to send and receive signals to/from FDD duplexer 605B.

In the examples discussed above, the systems in FIGS. 4 and 6 receive a WWAN signal that is in frequency divisional duplex (FDD) and a WLAN signal is in time division duplex (TDD). If the WWAN signal that is received is in TDD then the controllers from FIG. 4 or 6 may provide change the frequencies of the filters and the circuits may be simplified to not include the various switches that have been added to FIGS. 4 and 6. For example, in FIG. 4 switches 406A-406D, 405A-405D, 407A-407D and duplexers 406A-406D and related circuitry may be removed. In FIG. 4, the filter may be adjusted to switch between a TDD WWAN signal and a TDD WLAN signal. In FIG. 6, switches 607A-607B, 608A-608B, 606A-606B, and duplexers 605A-605B may be removed or may not be needed.

In various embodiments, each of the steps of the algorithm in the flow chart of FIGS. 3, 5, and 7 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the implementations disclosed herein may be implemented as electronic hardware, computer software embodied on a tangible medium, or combinations of both. To clearly illustrate this interchangeability of hardware and software, various illustrative components, blocks, modules, circuits, and steps have been described above generally in terms of their functionality. Whether such functionality is implemented as hardware or software embodied on a tangible medium depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more illustrative implementations, the functions described may be implemented in hardware, software or firmware embodied on a tangible medium, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A mobile device for wireless communication, comprising:
a carrier aggregation radio having two or more transceivers that are configured to aggregate two signals of a first signal type; and
at least one of the transceivers is further configured to receive a second signal type while at least one of the other transceivers continues to receive the first signal type.

2. The mobile device of claim 1, further comprising a transceiver controller that is configured to adjust a filter characteristic within the at least one of the transceivers to allow the at least one of the transceivers to receive the second signal type.

3. The mobile device of claim 1, further comprising a transceiver controller that is configured to switch filters in the at least one of the transceivers to allow the at least one of the transceivers to receive the second signal type.

4. The mobile device of claim 2, further comprising a baseband processor that is configured to detect the type of signal being received by the at least one transceiver;
wherein the baseband processor is configured to process a signal differently based on whether the transceiver is receiving the first signal type or the second signal type.

5. The mobile device of claim 2, wherein the transceiver controller informs a baseband processor regarding the change in the filter characteristic in the at least one of the transceivers and wherein the filter characteristic is a center frequency.

6. The mobile device of claim 1, wherein the first signal type is a WWAN signal and wherein the second signal type is a WLAN signal.

7. The mobile device of claim 1, further comprising a controller configured to transmit control signals to a plurality of single pole double throw switches of the at least one transceiver to create a signal path that bypasses a FDD duplexer.

8. The mobile device of claim 1, wherein the at least one of the transceivers include a plurality of single pole double throw switches that create a signal path to bypass a FDD duplexer.

9. A method for wireless communication, the method comprising:
receiving by a first transceiver a first type of signal;
receiving by a second transceiver a first type of signal;
carrier aggregating the signals received by the first transceiver and the signal the second transceiver;
detecting a second type of signal; and
switching the first transceiver to receive the second type of signal while the second transceiver continues to receive the first type of signal.

10. The method of claim 9, wherein the first transceiver and the second transceiver is configured to receive a WWAN signal during carrier aggregation.

11. The method of claim 9, wherein the first type of signal is a WWAN signal and the second type of signal is a WLAN signal.

12. The method of claim 9, wherein the switching is performed by a controller that is connected to the first transceiver;
further comprising sending a control signal to the first transceiver to bypass at least one FDD duplexer.

13. The method of claim 9, further comprising adjusting a characteristic of a filter within the first transceiver to allow the first transceiver to receive the second type of signal.

14. The method of claim 9, further comprises a transceiver controller that is configured to adjust a filter frequency and activate at least one of the single pole double throw switches within the at least one of the transceivers to allow the at least one transceiver to process the second signal type.

15. The method of claim 14, wherein the transceiver controller is configured to provide different control signals based on a signal that is being processed.

16. The method of claim 9, further comprising a transceiver controller configured to change at least one control signal to create a signal path within the first transceiver to process a second type of signal.

17. An apparatus for wireless communication, the apparatus comprising:
a means for carrier aggregating two signals of a first signal type received by a first transceiver and a second transceiver;
a means for receiving, by the first transceiver, a second signal type upon detecting a second signal type.

18. The apparatus of claim 17, further comprising a means for changing a characteristic of a filter within a first transceiver based on the second signal type.

19. The apparatus of claim 17, further comprising a means for detecting the second signal type.

20. The apparatus of claim 17, further comprising a mean for generating a first control signal to change the first transceiver to receive a second type of signal while the second transceiver continues to receive a first type of signal.
